(19) United States
(12) Patent Application Publication
(10) Pub. No.: US 2011/0265103 A1
(43) Pub. Date: Oct. 27, 2011

(54) OPTICAL DISC PLAYER

(75) Inventors: TENG-YUAN CHANG, Tu-Cheng (TW); FU-PIN HSIEH, Tu-Cheng (TW); CHIN-CHIA CHANG, Tu-Cheng (TW); SUNG-FENG TSAI, Tu-Cheng (TW)

(73) Assignee: HON HAI PRECISION INDUSTRY CO., LTD., Tu-Cheng (TW)

(21) Appl. No.: 12/870,990

(22) Filed: Aug. 30, 2010

(30) Foreign Application Priority Data
Apr. 23, 2010 (CN) 201010154539.4

(51) Int. Cl. G11B 17/04

(52) U.S. Cl. 720/601; G9B/17.013

(57) ABSTRACT

An optical disc player includes a lower housing, an upper housing, and a tray. The upper housing is adapted to combine with the lower housing to form a receiving space. The tray is adapted to load an optical disc. The tray divides the receiving space into a lower space and an upper space. The tray defines at least one through hole for communicating the lower space and the upper space.

### BACKGROUND

1. Technical Field

The present disclosure relates to optical disc players, and particularly to a quiet optical disc player.

2. Description of Related Art

An optical disc player often includes a lower housing, an upper housing, and a tray. The lower housing combines with the upper hosing to form a receiving space. The tray is received in the receiving space, and divides the receiving space into an upper space, and a lower space. The upper space is formed by the upper housing and part of the tray, and the lower space is formed by the lower housing and part of the tray.

In use, an optical disc is disposed on the tray, and received in the upper space formed by the upper housing and the tray. As such, when the optical disc player reads the optical disc, the optical disc rotates at high speeds causing rapid airflow to be confined to the upper space, thus causing air turbulence, vibration and noise.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of an optical disc player in accordance with an exemplary embodiment.

FIG. 2 is an exploded view of the optical disc player of FIG. 1 from one direction.

FIG. 3 is another exploded view of the optical disc player of FIG. 1 from a reverse direction to FIG. 2.

FIG. 4 is a schematic view of the optical disc player in FIG. 1 in use.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

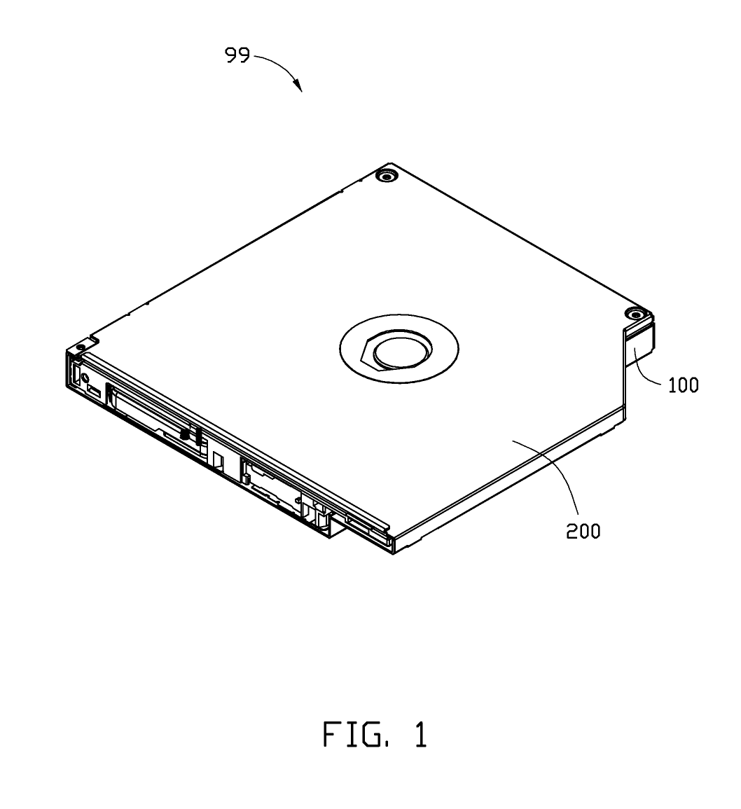

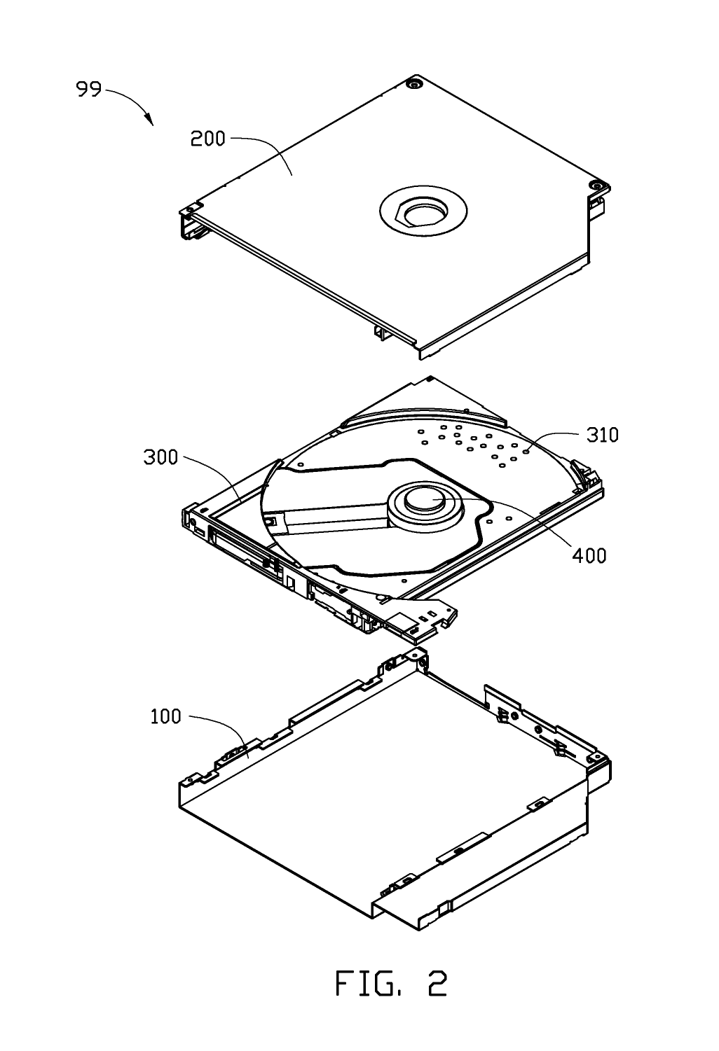

Referring to FIGS. 1 and 2, an optical disc player 99 includes a lower housing 100, an upper housing 200, a tray 300, and a spindle motor 400.

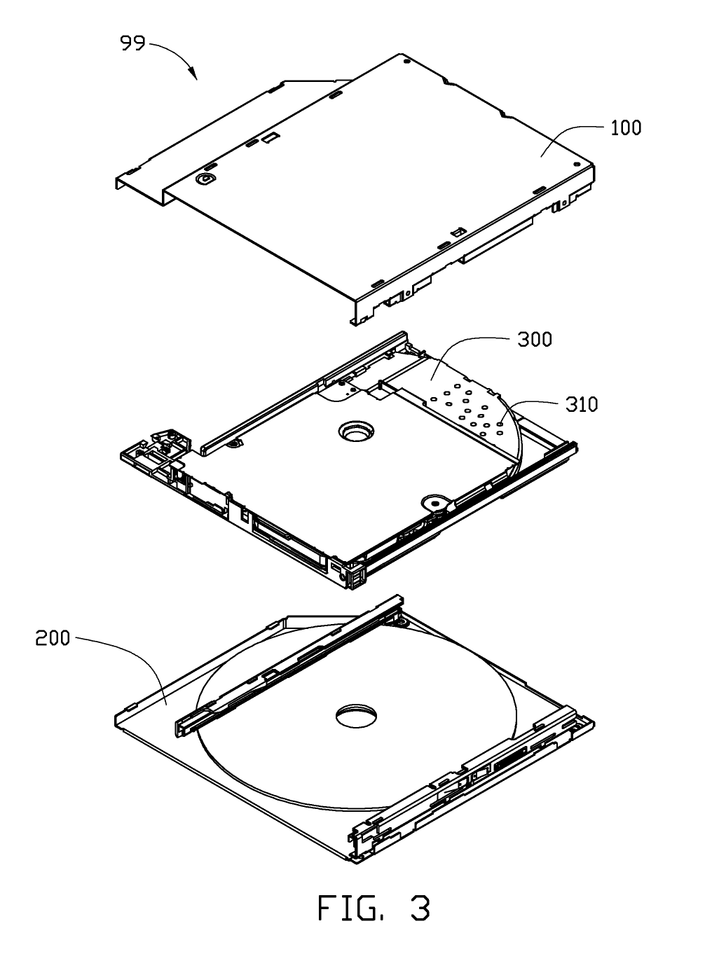

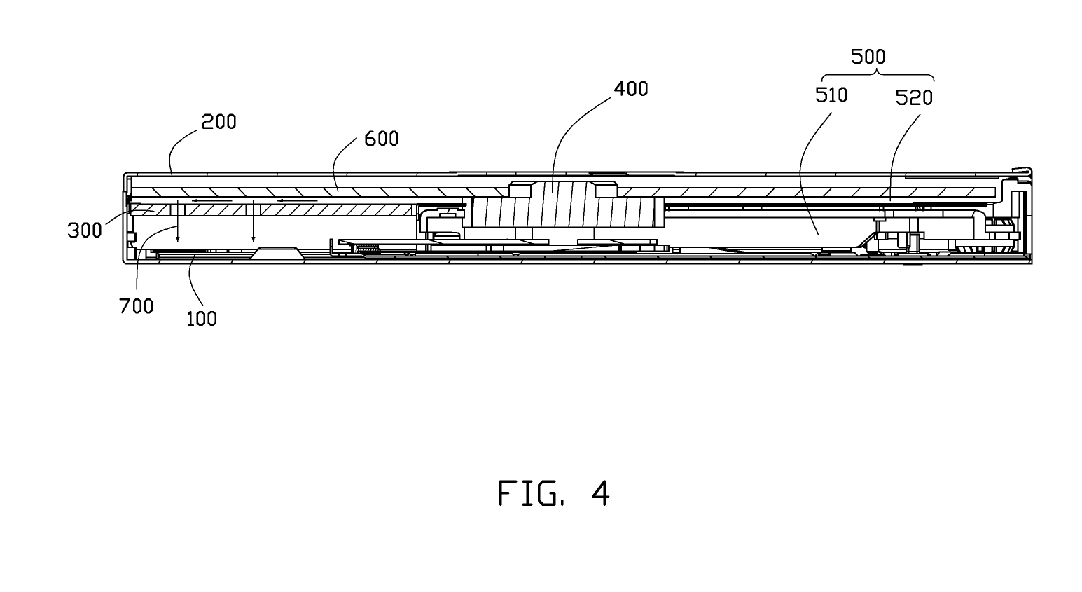

Referring further to FIG. 3-4, the lower housing 100 and the upper housing 200 combine to form a receiving space 500. The tray 300 and the spindle motor 400 are received in the receiving space 500.

The tray 300 is used for loading an optical disc 600. The tray 300 is disposed between the lower housing 100 and the upper housing 200, and divides the receiving space 500 into a lower space 510, and an upper space 520. The tray 300 defines a number of circular through holes 310 communicating the lower space 510 and the upper space 520.

The spindle motor 400 is used for rotating the optical disc 600, thus the optical disc player 99 can read the optical disc 600.

In use, the optical disc 600 is positioned on the spindle motor 400, and received in the upper space 520. When the spindle motor 400 rotates the optical disc 600 at high speed causing airflow, the air will flow from the upper space 520 to the lower housing 510 along directions of arrows 700. Therefore, the airflow is not confined and does not cause turbulence as in the prior optical disc player, thus vibration and the noise caused by the vibration can be decreased.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An optical disc player, comprising:
a lower housing;
an upper housing adapted to combine with the lower housing to form a receiving space; and
a tray adapted to load an optical disc, the tray dividing the receiving space into a lower space and an upper space, the tray defining at least one through hole for communicating the lower space and the upper space.

2. The optical disc player according to claim 1, wherein the optical disc is received in the upper space, and when the optical disc is rotated at high speed causing airflow, the air flows from the upper space to the lower space.

3. The optical disc player according to claim 1, wherein the at least one through hole is a number of through holes.

4. An optical disc player, comprising:
a lower housing;
an upper housing adapted to combine with the lower housing to form a receiving space; and
a tray adapted to load an optical disc, the tray dividing the receiving space into a lower space and an upper space;
wherein the optical disc is received in the upper space, and when the optical disc is rotated at high speed causing airflow, the air flows from the upper space to the lower space.

5. The optical disc player according to claim 4, wherein the air flows from the upper space to the lower space via at least one through hole communicating the lower space and the upper space.

6. The optical disc player according to claim 5, wherein the at least one through hole is a number of through holes.
